(19) United States
(12) Patent Application Publication
(10) Pub. No.: US 2025/0110310 A1
(43) Pub. Date: Apr. 3, 2025

(54) LENS UNIT, OPTICAL DEVICE INCLUDING LENS UNIT, AND IMAGE PICKUP APPARATUS INCLUDING LENS UNIT

(71) Applicant: CANON KABUSHIKI KAISHA, Tokyo (JP)

(72) Inventors: SATOSHI INOUE, Tochigi (JP); SHIGEO URAI, Saitama (JP)

(21) Appl. No.: 18/830,950

(22) Filed: Sep. 11, 2024

(30) Foreign Application Priority Data
Oct. 2, 2023 (JP) 2023-171416
Dec. 22, 2023 (JP) 2023-216630

(51) Int. Cl. G02B 7/02; G02B 13/00

(52) U.S. Cl. CPC G02B 7/028; G02B 7/021; G02B 7/026; G02B 13/003

(57) ABSTRACT

Provided is a lens unit capable of reducing a risk that desired optical performance cannot be obtained even when a temperature range of a use environment is wide. In a lens unit including a first lens and a second lens, a diameter D1 of an outer peripheral edge of a first lens first tapered portion is set larger than a diameter D2 of an outer peripheral edge of a second lens tapered portion, and the outer peripheral edge of the first lens tapered portion and the outer peripheral edge of the second lens tapered portion are spaced apart by a predetermined distance at a predetermined temperature. In an environment at a temperature higher or lower than the predetermined temperature, the distance between the outer peripheral edge of the first lens tapered portion and the outer peripheral edge of the second lens tapered portion is set smaller than the predetermined distance.

### BACKGROUND OF THE INVENTION

### Field of the Invention

The present disclosure relates to a lens unit, an optical device including the lens unit, and an image pickup apparatus including the lens unit.

### Description of the Related Art

Hitherto, when a lens is used in an optical device or an image pickup apparatus, in some cases, the lens is held by a holding member to form a lens unit, and the entire lens unit is mounted to the optical device or the image pickup apparatus for use. In such a lens unit, for example, a holding hole for placing the lens is formed in the holding member, and positioning of the lens in an optical axis direction is performed with the lens placed in the holding hole. The lens is fixed to a holding frame through use of, for example, an adhesive. For the purpose of not deteriorating optical performance of the optical device and the image pickup apparatus in this process, a method of positioning with high accuracy in fixing the lens position is disclosed in Japanese Patent Application Laid-Open No. 2013-113986.

In Japanese Patent Application Laid-Open No. 2013-113986, a mode in which one more holding member is added to an outer side of the lens as compared to a conventional mode is disclosed. Specifically, as holding members, there are used an outer holding member with a tapered hole portion having a certain taper angle, and an inner holding member with a cylindrical surface portion that is formed on an inner peripheral side and holds a lens side surface of the lens. The inner holding member is arranged on an outer peripheral side of the lens, and the tapered hole portion of the outer holding member and a tapered surface portion of the inner holding member, which has a taper angle equal to the taper angle of the hole portion, are brought into abutment against each other, thereby increasing the accuracy in positioning of the lens at the time of lens assembly.

However, when a range of an environmental temperature at which the optical device or the image pickup apparatus is used is wide, the lens is deformed depending on the temperature. In such cases, even when a plurality of lenses are positioned with high accuracy at the time of lens assembly, desired optical performance may not be obtained due to lens deformation such as expansion or contraction in a plane perpendicular to an optical axis, for example, at or around an upper limit or a lower limit of the environmental temperature.

The present disclosure has been made in view of such background, and therefore has an object to provide a lens unit capable of maintaining desired optical performance even when a temperature range in a use environment is wide.

### SUMMARY OF THE INVENTION

In order to solve the above-mentioned problem, according to one aspect of the present disclosure, there is provided a lens unit including:
a first lens including:
   a first lens tapered portion; and
   a first lens planar portion provided so as to be continuous with an outer periphery of the first lens tapered portion and perpendicular to an optical axis; and
a second lens, which is opposed to the first lens, and includes:
   a second lens tapered portion provided so as to be apart from and opposed to the first lens tapered portion; and
   a second lens planar portion that is provided so as to be continuous with an outer periphery of the second lens tapered portion and perpendicular to the optical axis, and is brought into abutment against the first lens planar portion,
wherein a diameter D1 of an outer peripheral edge of the first lens tapered portion is larger than a diameter D2 of an outer peripheral edge of the second lens tapered portion,
wherein the outer peripheral edge of the first lens tapered portion and the outer peripheral edge of the second lens tapered portion are spaced apart by a predetermined distance at a predetermined temperature, and
wherein in an environment at a temperature higher or lower than the predetermined temperature, a distance between the outer peripheral edge of the first lens tapered portion and the outer peripheral edge of the second lens tapered portion is smaller than the predetermined distance.

In order to solve the above-mentioned problem, according to one aspect of the present disclosure, there is provided a lens unit including:
a first lens including:
   a first lens first tapered portion; and
   a first lens second tapered portion provided continuously on an outer side of the first lens first tapered portion; and
a second lens, which is opposed to the first lens, and includes:
   a second lens first tapered portion provided so as to be apart from and opposed to the first lens first tapered portion; and
   a second lens second tapered portion that is brought into abutment against the first lens second tapered portion at an abutting portion and provided continuously on an outer side of the second lens first tapered portion.

Further features of the present invention will become apparent from the following description of exemplary embodiments with reference to the attached drawings.

### BRIEF DESCRIPTION OF THE DRAWINGS

FIG. 1 is a plan view of a lens unit according to one embodiment of the present disclosure.

FIG. 2 is a sectional view of the lens unit illustrated in FIG. 1, taken along the line A-A of FIG. 1.

FIG. 3 is an exploded sectional view of the lens unit illustrated in FIG. 2.

FIG. 4 is an enlarged sectional view of a contact region between a first lens and a second lens illustrated in FIG. 1.

FIG. 5 is a flowchart for illustrating one mode of a method of manufacturing the lens unit.

FIG. 6 is a sectional view for illustrating a modification example of the lens unit.

FIG. 7A is an external perspective view of an in-vehicle camera on which the lens unit according to the present disclosure is mounted.

FIG. 7B is a schematic view of components of the in-vehicle camera on which the lens unit according to the present disclosure is mounted.

FIG. 8 is a sectional view of a lens unit used in Example 2.

FIG. 9 is an exploded sectional view of a lens unit according to a second embodiment.

FIG. 10A is a sectional view of a first lens and a second lens, for illustrating dimensions and properties related to thermal deformation.

FIG. 10B is a sectional view of the first lens and the second lens of FIG. 9, for illustrating a relationship between individual lens tapered portions.

FIG. 11 is a sectional view for illustrating a modification example of the lens unit according to the second embodiment.

FIG. 12 is a flowchart for illustrating one mode of a method of manufacturing the lens unit according to the second embodiment.

### DESCRIPTION OF THE EMBODIMENTS

An exemplary embodiment for carrying out the present disclosure is described in detail with reference to the drawings. However, for example, the dimensions, materials, and relative positions of the components described in the following embodiment may be freely selected, and the device to which the present disclosure is applied may be changed based on various conditions. The same reference symbols are used to denote components that are the same as one another or functionally similar to one another among the drawings.

A lens unit according to the present disclosure is expected to be used in a temperature range from a low temperature of minus several tens of degrees Celsius to a high temperature of around 100 degrees Celsius in, for example, surveillance cameras used outdoors, and in-vehicle cameras. In the following description, for the sake of convenience, a direction along an optical axis of the lens unit is defined as an optical axis direction, and a direction along a plane orthogonal to the optical axis is defined as a horizontal direction.

### First Embodiment

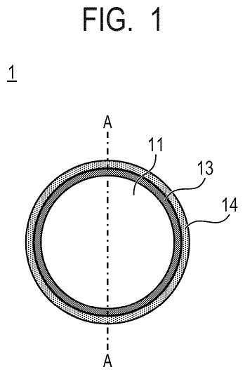

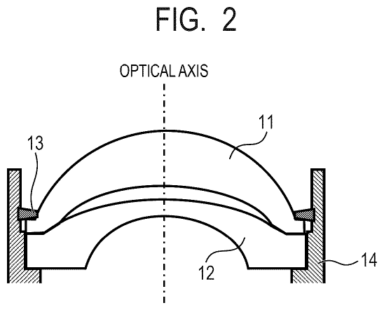

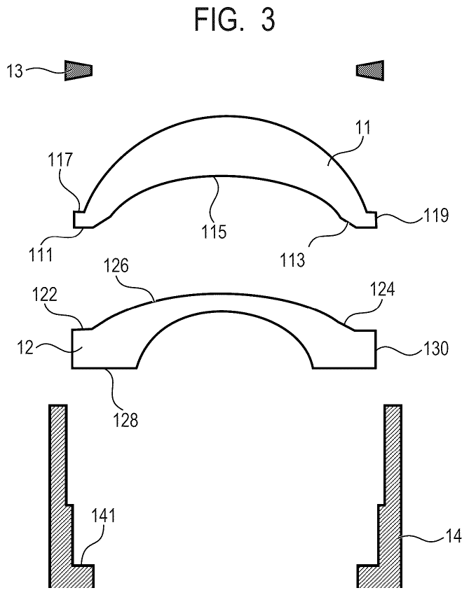

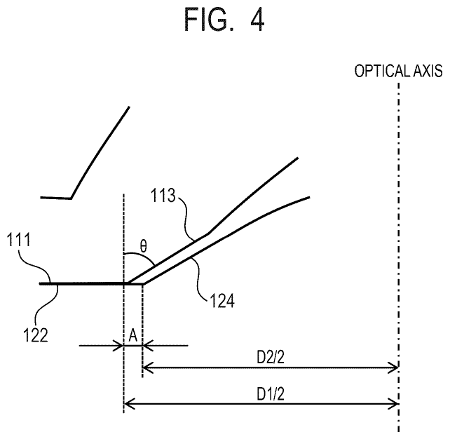

Now, a first embodiment of the present disclosure is described with reference to FIG. 1 to FIG. 5. FIG. 1 is a plan view of a lens unit 1 according to the first embodiment of the present disclosure, and FIG. 2 shows a schematic configuration of the lens unit 1 of FIG. 1 in a cross section taken along the line A-A of FIG. 1. Further, FIG. 3 is an exploded sectional view of the lens unit of FIG. 2, and FIG. 4 is an enlarged sectional view of a contact region between a first lens 11 and a second lens 12.

The lens unit 1 according to this embodiment includes the first lens 11, the second lens 12, a retaining member 13, and a holding member 14. In this embodiment, the retaining member 13 has a ring shape. The holding member 14 has a cylindrical shape, and includes an abutment portion 141 protruding inwardly on one end portion side of the cylindrical shape. Both the lenses are inserted into the cylindrical shape in the order of the second lens 12 and the first lens 11 until the second lens 12 is brought into abutment against the abutment portion 141. Then, the retaining member 13 is inserted inside the cylindrical shape after the first lens 11, and those lenses are sandwiched between the holding member abutment portion 141 and the retaining member 13, thereby fixing those lenses in the holding member 14.

The lens unit 1 is mounted on a surveillance camera or an in-vehicle camera. Thus, the lens unit 1 is expected to be exposed to, for example, from a low temperature environment of −40 degrees Celsius to a high temperature environment of 100 degrees Celsius. Here, the first lens 11 and the second lens 12 are often manufactured as glass lenses made of different materials. In this case, linear expansion coefficients of the lenses are also different. When an environmental temperature changes, for example, in shapes of the first lens and the second lens, which are described later in detail, lens surfaces or edges of tapered surfaces to be described later may come into contact with each other due to, for example, expansion in a radial direction, and thus a positional relationship in the radial direction may change. Such a change in the positional relationship caused by the environmental temperature may cause, for example, a problem in that, even when predetermined optical performance is achieved at the time of lens assembly in a room temperature environment of 25 degrees Celsius, the optical performance cannot be obtained in an environmental temperature of −40 degrees Celsius or 100 degrees Celsius.

The present disclosure is obtained from such a viewpoint. The lens unit 1 according to this embodiment suppresses changes in lens spacing and reduces deterioration of optical performance even when thermal expansion or thermal contraction occurs in individual lenses due to the environmental temperature of −40 degrees Celsius or 100 degrees Celsius. Next, a specific method of suppressing changes in lens spacing is described.

FIG. 3 is an exploded sectional view of the lens unit 1 described above. As illustrated in FIG. 3, the first lens 11 includes a first lens planar portion 111, a first lens tapered portion 113, a first lens optical surface 115, a first lens retaining surface 117, and a first lens side surface 119. The first lens optical surface 115 is a surface that is positioned so as to be opposed to the second lens 12, and forms an optically effective portion of the first lens 11. The first lens planar portion 111 is formed of a planar surface that is perpendicular to the optical axis and provided around an outer periphery of the first lens optical surface 115 being a surface on a side on which the second lens 12 is located. The first lens tapered portion 113 is a surface provided around the outer periphery of the first lens optical surface 115 and around an inner periphery of the first lens planar portion 111, and is configured to have a conical surface shape. In this embodiment, the first lens tapered portion 113 is provided so as to be continuous with the first lens optical surface 115 at the outer periphery of the first lens optical surface 115 and continuous with the first lens planar portion 111 at the inner periphery of the first lens planar portion 111. However, between the outer periphery of the first lens optical surface 115 and the first lens tapered portion 113, a first rounded portion with a curvature different from that of the first lens optical surface 115 may be provided, and a non-continuous mode can be also employed. Further, between the first lens tapered portion 113 and the first lens planar portion 111, a second rounded portion with a curvature may be provided, and a non-continuous mode can be also employed. The first lens retaining surface 117 is provided around an outer periphery of a surface on a side opposite to the second lens 12, and is a surface to be brought into abutment against the retaining member 13. The first lens side surface 119 is configured as a surface that is parallel to the optical axis and opposed to an inner peripheral surface of the holding member 14.

The second lens 12 includes a second lens planar portion 122, a second lens tapered portion 124, a second lens optical surface 126, a holding member contact surface 128, and a second lens side surface 130. The second lens optical surface 126 is a surface that is arranged so as to be opposed to the first lens optical surface 115, and forms an optically effective portion of the second lens 12. The second lens planar portion 122 is formed of a planar surface that is perpendicular to the optical axis and provided around an outer periphery of the second lens optical surface 126 being a surface on a side on which the first lens 11 is located. The second lens tapered portion 124 is a surface provided around the outer periphery of the second lens optical surface 126 and around an inner periphery of the second lens planar portion 122, and is configured to have a conical surface shape. In this embodiment, the second lens tapered portion 124 is provided so as to be continuous with the second lens optical surface 126 at the outer periphery of the second lens optical surface 126. However, between the outer periphery of the second lens optical surface 126 and the second lens tapered portion 124, a third rounded portion with a curvature different from that of the second lens optical surface 126 may be provided, and a non-continuous mode can be also employed. Further, between the second lens tapered portion 124 and the second lens planar portion 122, a fourth rounded portion with a curvature may be provided, and a non-continuous mode can be also employed. The holding member contact surface 128 is a surface to be brought into abutment against the holding member abutment portion 141. The second lens side surface 130 is configured as a surface that is parallel to the optical axis and opposed to the inner peripheral surface of the holding member 14.

In this case, inner diameters and outer diameters of the first lens planar portion 111 and the second lens planar portion 122 are determined so that at least portions of annular shapes of the planar portions can be brought into abutment against each other. Further, the outer diameter and inner diameter of the first lens tapered portion 113 and the outer diameter and inner diameter of the second lens tapered portion 124 are determined in accordance with the outer diameters and inner diameters of those tapered portions, a relationship between the linear expansion coefficients of the first lens 11 and the second lens 12, and an assumed environmental temperature.

Specifically, α1 represents a linear expansion coefficient of the first lens 11, which has a large tapered-portion inner diameter, and D1 [mm] represents an outer diameter at an outer peripheral edge of the tapered portion. Further, α2 represents a linear expansion coefficient of the second lens 12, which has a small tapered-portion inner diameter, and D2 [mm] represents an outer diameter at an outer peripheral edge of the tapered portion.

TH and TL represent a highest environmental temperature and a lowest environmental temperature, respectively, and A [mm] represents a clearance amount in the radial direction between the tapered portion outer diameter D1 of the first lens tapered portion 113 and the tapered portion outer diameter D2 of the second lens tapered portion 124 at an environmental temperature of 25 degrees Celsius under a state in which the first lens planar portion 111 and the second lens planar portion 122 are substantially held in abutment against each other. At this time, when the relationship between the linear expansion coefficients satisfies α1<α2, the clearance amount A becomes smaller when the environmental temperature becomes higher. In this case, the minimum value of the clearance amount A that changes due to a temperature rise is determined by Formula (1) below. When the highest environmental temperature TH in this case is in a range of from 25 degrees Celsius to 80 degrees Celsius, the clearance amount A is equal to or larger than a distance determined by 55×(α2−α1)×D2 when the relationship between the linear expansion coefficients satisfies α1<α2. Further, when the highest environmental temperature TH is in a range of from 25 degrees Celsius to 100 degrees Celsius, the clearance amount A is equal to or larger than a distance determined by 75×(α2−α1)×D2 when the relationship between the linear expansion coefficients satisfies α1<α2.

$$A = ( T H - 25 ) \times ( α 2 - α 1 ) \times D 2 \qquad ( Formula 1 )$$

Further, when the relationship between the linear expansion coefficients satisfies α1>α2, the clearance amount A becomes smaller when the environmental temperature becomes lower. In this case, the value of the clearance amount A that changes due to a temperature drop is determined by Formula (2) below. When the lowest environmental temperature TL in this case is in a range of from 25 degrees Celsius to −20 degrees Celsius, the clearance amount A is equal to or larger than a distance determined by 45×(α1−α2)×D1 when the relationship between the linear expansion coefficients satisfies α1>α2. Further, when the lowest environmental temperature TL is in a range of from 25 degrees Celsius to −40 degrees Celsius, the clearance amount A is equal to or larger than a distance determined by 65×(α1−α2)×D1 when the relationship between the linear expansion coefficients satisfies α1>α2.

$$A = ( 25 - TL ) \times ( α 1 - α 2 ) \times D 1 \qquad ( Formula 2 )$$

A temperature during manufacture of the lens unit 1 (25 degrees Celsius) can be defined as a reference temperature Ts, and an assumed operating temperature (TH, TL) can be defined as Td. In this case, the portion (TH−25)× (α2−α1) and the portion (25−TL)×(α1−α2) in the above-mentioned two formulae can be summarized as a coefficient (Td−Ts)× (α2−α1). When Td≥Ts is satisfied, the clearance amount A is determined based on this coefficient and the tapered portion outer diameter D2 of the second lens 12, and when Td<Ts is satisfied, the clearance amount A is determined based on this coefficient and the tapered portion outer diameter D1 of the first lens 11. Further, the tapered portion outer diameter D1 of the first lens tapered portion 113 is set to D2+A≤D1≤D2+2A. The more preferred tapered portion outer diameter D1 of the first lens tapered portion 113 is D2+A.

At the reference temperature Ts, a difference between the tapered portion outer diameter D1 and the tapered portion outer diameter D2 is set to a value larger than the clearance amount A calculated above. When such a value is set for the difference between those outer diameters at the reference temperature Ts, contact between the tapered portions of the lenses due to thermal deformation can be avoided in an entire environmental temperature range of from −40 degrees Celsius to 100 degrees Celsius. In addition, occurrence of climbing of the tapered portions can be suppressed. As a result, even when thermal expansion or thermal contraction of each lens occurs, a risk that the desired optical performance cannot be obtained in the lens unit 1 can be reduced.

Next, a suitable taper angle θ of the tapered surface of each lens is described with reference to FIG. 4. FIG. 4 is an enlarged sectional view of the contact region between the first lens 11 and the second lens 12.

In the following description, the taper angle θ is an angle formed between the optical axis and the tapered surface in the cross section taken along the line A-A of FIG. 1.

Here, when it is intended to stably obtain a lens-to-lens distance between the first lens 11 and the second lens 12 in the optical axis direction during assembly of the lens unit 1, it is preferred that the taper angle θ be equal to or larger than 45 degrees and smaller than 90 degrees. When the taper angle θ is set to such a value, the second lens 12 and the first lens 11 can be easily inserted into the holding member 14 until abutment surfaces of the second lens 12 and the first lens 11 are brought into abutment against each other. Further, in order to bring the first lens planar portion 111 and the second lens planar portion 122 of both the lenses into abutment against each other, the first lens tapered portion 113 and the second lens tapered portion 124 are required to have a gap, and hence it is preferred that both the tapered portions have the same taper angle θ.

Further, during assembly of the lens unit 1, the first lens 11 is pushed inside the holding member 14 while the first lens tapered portion 113 is held in partial contact with the second lens tapered portion 124. When the work of insertion of the first lens 11 into the holding member 14 is continued under this state, the first lens 11 is aligned with the second lens 12, and finally the first lens planar portion 111 is brought into abutment against the second lens planar portion 122, thereby completing the work of insertion. Here, in a case in which a static friction coefficient between the second lens planar portion 122 and the first lens planar portion 111 is equal to or smaller than 0.5, when the taper angle θ is smaller than 67 degrees, a particularly suitable alignment is performed even when a load during pushing is minute. Further, when horizontal vibration (in a direction in a plane perpendicular to the pushing-in direction) is applied while satisfying a condition of this taper angle θ, alignment can be performed more smoothly.

From the above description, it is preferred that the taper angle θ of the first lens tapered portion 113 be equal to the taper angle θ of the second lens tapered portion 124, and be equal to or larger than 45 degrees and smaller than 90 degrees with respect to the optical axis of the lens from the viewpoint of lens processability and ease of assembly. From the viewpoint of alignment of both the lenses, it is more preferred that the taper angle θ be equal to or larger than 45 degrees and smaller than 67 degrees. Through satisfaction of this condition for the taper angle θ, even when thermal expansion or thermal contraction of each lens occurs, the lens unit 1 can be easily manufactured with reduced risk that the desired optical performance cannot be obtained.

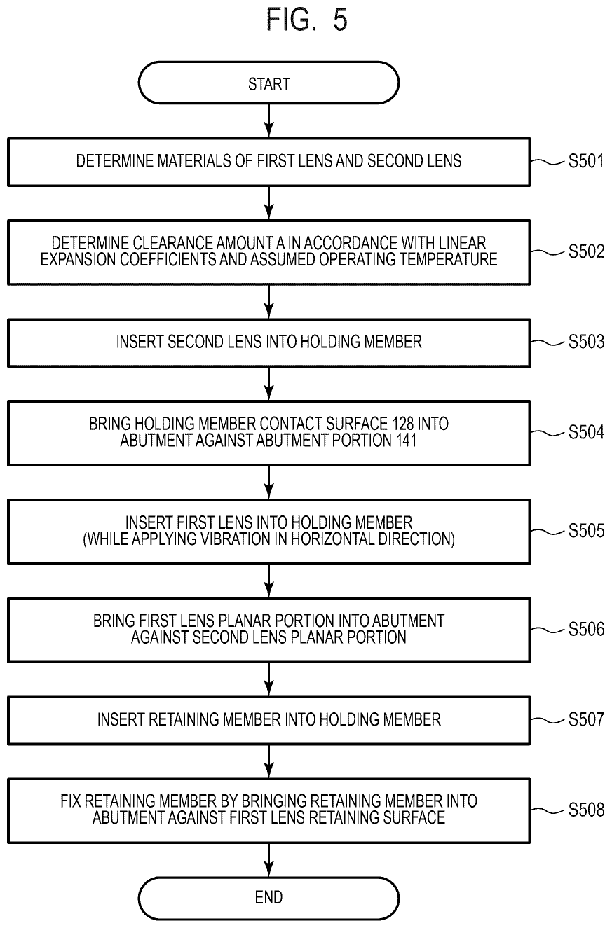

Next, assembly of the lens unit 1 according to one aspect of the present disclosure is described with reference to a flowchart in FIG. 5. The assembly of the lens unit 1 is carried out at a normal temperature of 25 degrees Celsius. Further, the lens unit 1 is assembled, which is configured so that the highest environmental temperature TH is 100 degrees Celsius and the clearance amount A is 5 μm (0.005 mm) at a temperature of 25 degrees Celsius.

First, in Step S501, based on optical conditions required for the lens unit 1, a material of the first lens 11, a material of the second lens 12, and a shape of each optical surface are determined. Next, in Step S502, the linear expansion coefficient α1 of the first lens 11, the linear expansion coefficient α2 of the second lens 12, the environmental temperature (reference temperature Ts) during manufacture of the lens unit, and the assumed operating temperature (Td) are referenced. Then, based on the above-mentioned coefficients and temperatures, and the relationship in value between Ts and Td, a decision is made as to which one is to be used. The clearance amount A is determined based on any of the tapered portion outer diameter D1 of the first lens 11 and the tapered portion outer diameter D2 of the second lens 12. This determines dimensions of the first lens 11 and dimensions of the second lens 12, and those lenses are manufactured.

Next, as illustrated in FIG. 5, in Step S503, the second lens 12 is inserted into the holding member 14. This operation is completed by bringing the holding member contact surface 128 of the second lens and the abutment portion 141 of the holding member 14 into abutment against each other in Step S504. At this time, the second lens side surface 130 of the second lens may or may not be held in contact with the holding member 14.

Next, in Step S505, the first lens 11 is inserted into the holding member 14. At this time, when the taper angle θ of the first lens tapered portion 113 and the taper angle θ of the second lens tapered portion 124 with respect to the optical axis are equal to or larger than 67 degrees and smaller than 90 degrees, insertion is performed while applying vibration to the holding member 14 and the first lens 11 in a direction (horizontal direction) in a plane perpendicular to the inserting direction. This operation is completed by bringing the first lens planar portion 111 into abutment against the second lens planar portion 122 in Step S506.

When the first lens 11 and the second lens 12 are made of a glass material and the taper angle θ is equal to or larger than 67 degrees and smaller than 90 degrees, through application of vibration in the horizontal plane during insertion of the first lens 11 as described above, the optical axes of those lenses are aligned. Accordingly, when any one of the first lens side surface 119 of the first lens 11 and the second lens side surface 130 of the second lens 12 is fixed to the inner periphery of the holding member 14, the other lens is also arranged at a desired position with respect to the holding member 14. Further, by determining which of the first lens side surface 119 and the second lens side surface 130 is brought into abutment against the holding member 14 according to the relationship in difference between the assumed temperature Td and the reference temperature Ts during use, it is possible to eliminate constraint from the abutment surface on thermal deformation of the lens that is free from abutment. As described above, only one of those lenses is brought into abutment against the inside of the holding member 14, which facilitates alignment of each lens in the optical axis direction. However, in cases in which constraint on the lens outer diameter by the holding member 14 is not so problematic, for example, when the assumed temperature Td is not so different from the reference temperature Ts, or when the holding member 14 is relatively easily deformable, both the lenses may be brought into abutment against the inside of the holding member 14.

Finally, in Step S507, the retaining member 13 is inserted into the holding member 14. Then, in Step S508, the retaining member 13 is fixed to the holding member 14 by bringing the retaining member 13 into abutment against the first lens retaining surface 117. The lens unit according to the present disclosure can be manufactured, for example, through the above-mentioned process.

In the embodiment described above, the retaining member 13 is illustrated as, for example, a cylindrical part such as a caulking ring, but its mode is not limited to the shape of the embodiment. For example, parts such as a plurality of claws or screws can be used as the retaining member 13. Further, the manufacturing method described above is an example, and the process other than the method of determining the clearance amount A in Step S502 can be substituted by various known and available methods.

Further, in order to obtain the effect of the present disclosure, it is preferred that both the lenses expand or contract individually according to the environmental temperature, and thus it is preferred that the first lens optical surface 125 of the first lens 11 and the second lens optical surface 126 of the second lens 12 be spaced apart from each other. However, the present disclosure is not limited to this mode, and as long as a certain degree of deformation is allowed for both the lenses, an optical resin or the like may be filled between both the optical surfaces.

### Modification Example of First Embodiment

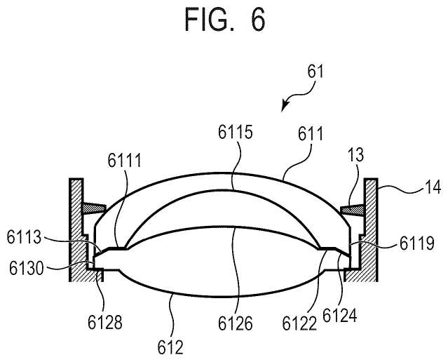

In the first embodiment, as illustrated in FIG. 3, in the first lens 11, the first lens planar portion 111 and the first lens tapered portion 113 have such positional relationship that the planar portion is on the outer peripheral side. Further, in the second lens 12, the second lens planar portion 122 and the second lens tapered portion 124 have such positional relationship that the planar portion is on the outer peripheral side. However, the positional relationship between the planar portion and the tapered portion in the lens may be reversed. This form is described later with reference to FIG. 6. FIG. 6 shows a lens unit 61 according to this modification example in the same manner as that in FIG. 2 or FIG. 3.

In this modification example, a first lens 611 includes a first lens planar portion 6111, a first lens tapered portion 6113, a first lens optical surface 6115, and a first lens side surface 6119. In this modification example, there is no surface corresponding to the first lens retaining surface 117, and the retaining member 13 presses an upper curved surface of the first lens 611 to a second lens 612 side in the optical axis direction. The first lens optical surface 6115 is a surface that is positioned so as to be opposed to the second lens 612, and forms an optical surface of the first lens 611. The first lens planar portion 6111 is formed of a planar surface that is perpendicular to the optical axis and provided around the outer periphery of the first lens optical surface 6115 being a surface on a side on which the second lens 612 is located. The first lens planar portion 6111 is a surface provided so as to be continuous with the first lens optical surface 6115 at the outer periphery of the first lens optical surface 6115 and continuous with the first lens planar portion 6111 at the inner periphery of the first lens tapered portion 6113. The first lens tapered portion 6113 is configured to have a conical surface shape. The first lens side surface 6119 is configured as a surface that is parallel to the optical axis and opposed to the inner peripheral surface of the holding member 14.

The second lens 612 includes a second lens planar portion 6122, a second lens tapered portion 6124, a second lens optical surface 6126, a holding member contact surface 6128, and a second lens side surface 6130. The second lens optical surface 6126 is a surface that is arranged so as to be opposed to the first lens optical surface 6115, and forms an optical surface of the second lens 612. The second lens planar portion 6122 is formed of a planar surface that is perpendicular to the optical axis and provided around the outer periphery of the second lens optical surface 6126 being a surface on a side on which the first lens 611 is located. The second lens tapered portion 6124 is a surface provided so as to be continuous with the second lens planar portion 6122 at the outer periphery of the second lens planar portion 6122, and is configured to have a conical surface shape. The holding member contact surface 6128 is a surface to be brought into abutment against the holding member abutment portion 141. The second lens side surface 6130 is configured as a surface that is parallel to the optical axis and opposed to the inner peripheral surface of the holding member 14.

In the lens unit 61 having such a configuration, the clearance amount A between the inner peripheral edges of both the tapered portions 6113, 6124 under a state in which the first lens planar portion 6111 and the second lens planar portion 6122 are held in abutment against each other can be obtained by the same formula as that in the first embodiment. Accordingly, even with the lens unit 61 having such a configuration, even when thermal expansion or thermal contraction of each lens occurs, a risk that the desired optical performance cannot be obtained can be reduced.

### Application Example of First Embodiment

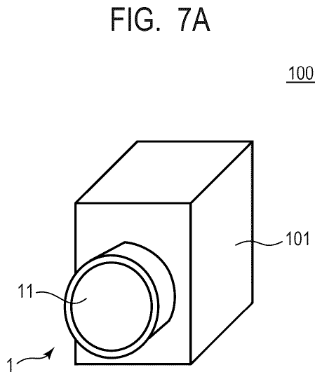

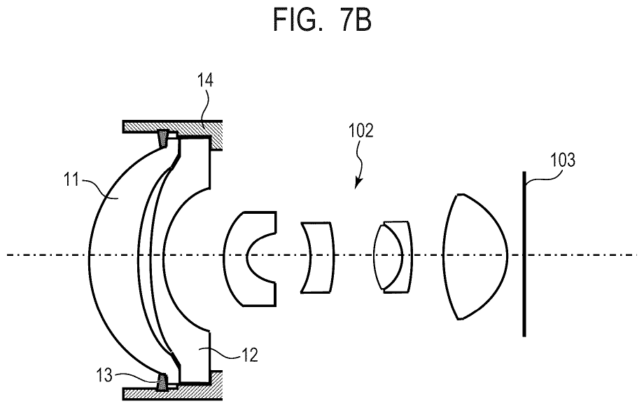

An image pickup apparatus including the above-mentioned lens unit 1 according to the first embodiment mounted thereon is described next with reference to the drawings with regard to an in-vehicle camera, which is an example of the image pickup apparatus. FIG. 7A and FIG. 7B are views for illustrating a schematic configuration of the in-vehicle camera of the present disclosure. FIG. 7A is an external perspective view, and FIG. 7B is a schematic view of components.

The in-vehicle camera 100 according to the present disclosure includes an internal optical system 102, an image pickup element 103, and a housing 101. The optical system 102 includes a plurality of lenses. The image pickup element 103 receives light having passed through the optical system. The housing 101 houses those components, and the lens unit 1 described as the first embodiment is applied to the housing 101. The in-vehicle camera 100 is expected to be mounted on, for example, an automobile that is exposed to direct sunlight outdoors in summer, and to be placed in a temperature environment of several tens of degrees Celsius. Through use of the lens unit 1 according to the first embodiment, in the lens unit 1, even under such an environment, it is possible to reduce the risk that the desired optical performance cannot be obtained. The image pickup element 103 is, for example, a complementary metal oxide semiconductor (CMOS) image sensor or a charge coupled device (CCD) image sensor. The image sensor has the function of converting light incident through the optical system 102 into an electrical signal.

As described above, the lens unit 1 according to the present disclosure includes at least the first lens 11 and the second lens 12. The first lens 11 includes, for example, the first lens optical surface 115, the first lens tapered portion 113 provided around the outer periphery of the first lens optical surface 115, and the first lens planar portion 111 provided around the outer periphery of the first lens optical surface 115 so as to be perpendicular to the optical axis. The second lens 12 includes, for example, the second lens optical surface 126 to be opposed to the first lens optical surface 115, and the second lens tapered portion 124 provided around the outer periphery of the second lens optical surface 126 so as to be opposed to the first lens tapered portion 113. The second lens 12 further includes the second lens planar portion 122 that is provided around the outer periphery of the second lens optical surface 126 so as to be perpendicular to the optical axis and arranged so as to be brought into abutment against the first lens planar portion 111. The linear expansion coefficient α1 of the first lens 11 and the linear expansion coefficient α2 of the second lens 12 are selected when the tapered portion outer diameter D1 of the outer peripheral edge of the first lens tapered portion 113 is larger than the tapered portion outer diameter D2 of the outer peripheral edge of the second lens tapered portion 124. This selection is made so that the distance between those outer peripheral edges decreases as the difference between the reference temperature Ts during manufacture and the assumed temperature Td during use increases. Further, when D1 is larger than D2, a predetermined distance (clearance amount A) at the reference temperature Ts between the outer peripheral edge of the first lens tapered portion and the outer peripheral edge of the second lens tapered portion under a state in which the first lens planar portion 111 and the second lens planar portion 122 are held in abutment against each other is determined as follows. That is, when Td≥Ts is satisfied, the predetermined distance is determined based on D2 as shown in Formula (1), and when Td<Ts is satisfied, the predetermined distance is determined based on D1 as shown in Formula (2). Specifically, it is preferred that the outer diameter D1 of the outer peripheral edge of the first lens tapered portion 113 be set larger than the outer diameter D2 of the outer peripheral edge of the second lens tapered portion 124. Further, in this case, in an environment at a temperature of 25 degrees Celsius, the distance between the outer peripheral edge of the first lens tapered portion 113 and the outer peripheral edge of the second lens tapered portion 124 is set apart by a predetermined distance. In an environment at a temperature higher or lower than 25 degrees Celsius, the distance between the outer peripheral edge of the first lens tapered portion 113 and the outer peripheral edge of the second lens tapered portion 124 is set so as to be smaller than the predetermined distance.

More specifically, when Td≥Ts is satisfied, the clearance amount A is determined by the difference between Td and Ts, the difference between α1 and α2, and D2 (Formula (1)). Further, when Td<Ts is satisfied, the clearance amount A is determined by the difference between Td and Ts, the difference between α1 and α2, and D1 (Formula (2)). In the embodiment described above, 25 degrees Celsius, which is the temperature during manufacture, is adopted as the reference temperature Ts because, for example, it is easy to determine the diameter at the time of design. However, the reference temperature Ts is not limited to this. For example, in consideration of mounting the lens unit on an in-vehicle camera, the average temperature in the use environment of the in-vehicle camera may be used as the reference temperature Ts. Further, a temperature of 100 degrees Celsius is adopted as the assumed temperature Td in the embodiment, but the upper limit of the assumed temperature is not limited to 100 degrees Celsius. For example, the upper limit of the assumed temperature may be set by multiplying a safety factor to the highest value of the temperature of the in-vehicle camera actually measured outdoors. When Ts is the temperature of 25 degrees Celsius and Td is the temperature of 100 degrees Celsius as in the embodiment, the clearance amount A can be set so as to be equal to or larger than the distance determined by 75×(α2−α1)×D2, which is obtained from Formula (1).

Further, in the embodiment described above, the case in which Td is a temperature of −40 degrees Celsius and used as the lower limit of the assumed temperature is adopted. However, for example, the lower limit of the assumed temperature may be set by multiplying a safety factor to the lowest value of the temperature of the in-vehicle camera actually measured outdoors. When Ts is the temperature of 25 degrees Celsius and Td is the temperature of −40 degrees Celsius as in the embodiment, the clearance amount A may be set so as to be equal to or larger than the distance determined by 65×(α1−α2)×D1, which is obtained from Formula (2).

It is preferred that the angles between the first lens tapered portion 113 of the first lens 11 and the optical axis and between the second lens tapered portion 124 of the second lens 12 and the optical axis be equal to or larger than 45 degrees and smaller than 90 degrees from the viewpoint of manufacturing the lens unit 1. It is more preferred that the angles be equal to or larger than 45 degrees and smaller than 67 degrees.

As described above, the lens unit 1 according to the present disclosure also includes the holding member 14 that accommodates the first lens 11 and the second lens 12 and includes the abutment portion 141 that is brought into abutment against the holding member contact surface 128 provided on a surface opposite to the second lens planar portion 122. The abutment portion 141 can be provided to protrude inwardly from the inner peripheral surface of the holding member 14 having a cylindrical shape. The lens unit 1 further includes the retaining member 13 that is brought into abutment against the surface (117) opposite to the first lens planar portion 111 and sandwiches the first lens 11 and the second lens 12 together with the abutment portion 141. At least one or both of the outer peripheral surface (side surface 119) of the first lens 11 and the outer peripheral surface (side surface 130) of the second lens 12 can be brought into abutment against the inner peripheral surface of the holding member 14. Further, in the illustrated embodiment, the first lens optical surface 115 and the second lens optical surface 126 are spaced apart from each other. However, the present disclosure is not limited to the embodiment, and, for example, an optical resin may be filled between those optical surfaces.

Further, the present disclosure may also be constructed as a method of manufacturing the lens unit described above. The method includes inserting the second lens 12 into the holding member 14, and inserting the first lens 11 into the holding member 14 and continuing the insertion until the first lens planar portion 111 is brought into abutment against the second lens planar portion 122. The method further includes inserting the retaining member 13 into the holding member 14 to fix those lenses to the holding member 14. Further, when the lenses are fixed, the retaining member 13 presses and fixes the first lens 11 in the inserting direction of the first lens 11 from the surface opposite to the surface of the first lens 11 provided with the first lens planar portion 111. Here, the diameter of the outer peripheral edge of the first lens tapered portion 113 is referred to as the tapered portion outer diameter D1, and the diameter of the outer peripheral edge of the second lens tapered portion 124 is referred to as the tapered portion outer diameter D2. α1 represents the linear expansion coefficient of the first lens 11, and α2 represents the linear expansion coefficient of the second lens 12. Ts represents the reference temperature during manufacture of the lens unit 1, and Td represents the assumed temperature during use of the lens unit 1. Further, it is assumed that D1 is larger than D2 in the lens unit 1. At this time, under a state in which the first lens planar portion 111 and the second lens planar portion 122 are held in abutment against each other, the clearance amount A at Ts is obtained, which is determined based on D2 when Td≥Ts is satisfied and determined based on D1 when Td<Ts is satisfied. Then, D1 set by D1=D2+2A in the first lens 11 is used as the outer diameter of the first lens tapered portion.

Through use of the lens unit 1 as described above or the lens unit 1 obtained by the manufacturing method, in the lens unit 1, even under, for example, the use environment of the in-vehicle camera, it is possible to reduce the risk that the desired optical performance cannot be obtained. Although the present disclosure has described the example of applying the lens unit 1 to an in-vehicle camera, the lens unit 1 is also applicable to image pickup apparatus other than in-vehicle cameras, such as compact digital cameras, single-lens reflex digital cameras, mirror-less digital cameras, and mobile devices such as smartphones and tablets. Further, the lens unit 1 is also applicable to optical devices such as binoculars, microscopes, and telescopes.

### EXAMPLES

Now, the effects of the present disclosure are described with reference to examples embodying the present disclosure and comparative examples with respect to the examples. The following examples are examples of the present disclosure, and the present disclosure is not limited to the following examples.

Further, a positional variation of each lens in the optical axis direction was measured under a state in which CL-P015 and CL-P070 of the CL-3000 series multicolor laser coaxial displacement meter manufactured by KEYENCE were arranged above and below the lens unit 1.

### Example 1

The lens unit 1 in this example has the cross-sectional shape illustrated in FIG. 2. In this example, M-TAFD305 (manufactured by HOYA: linear expansion coefficient α1=60×10⁻⁷/° C.) was used for the first lens 11. Further, the lens shape was a convex meniscus lens with an outer diameter of Φ32.4 mm, an overall height of 10.0 mm, a center thickness of 5.0 mm, and an edge thickness of 1.7 mm. M-BACD12 (manufactured by HOYA: linear expansion coefficient α2=69×10⁻⁷/° C.) was used for the second lens 12. The lens shape was a concave meniscus lens with an outer diameter of Φ32.4 mm, an overall height of 7.6 mm, a center thickness of 1.9 mm, an edge thickness of 3.6 mm, and a tapered portion outer diameter D2 of Φ28.0 mm. The lens unit was designed with the highest environmental temperature TH set at 100 degrees Celsius.

In this example, the relationship between the linear expansion coefficient α1 of the first lens 11, which has a large tapered portion outer diameter D1, and the linear expansion coefficient α2 of the second lens 12, which has a small tapered portion outer diameter D2, satisfies α1≤α2. Here, assuming that the reference temperature Ts is 25 degrees Celsius, which is the environmental temperature during manufacture, the clearance amount A between the outer peripheral edge of the first lens tapered portion 113 and the outer peripheral edge of the second lens tapered portion 124 can be calculated from Formula (1) below.

$$A = ( T H - 25 ) \times ( α 2 - α 1 ) \times D 2 \qquad ( Formula 3 )$$

From A≈0.002 [mm], the tapered portion outer diameter D1 of the first lens 11 can be obtained by adding A to D2, thereby obtaining the outer diameter D1 of @28.002. Further, the angles between the first lens tapered portion 113 and the optical axis and between the second lens tapered portion 124 and the optical axis were set to 60 degrees, and the planar portion was arranged outside the tapered portion.

Next, at a place at an indoor temperature of 25 degrees Celsius, the second lens 12 and the first lens 11 were inserted into the holding member 14 in the stated order. At this time, through application of a force from the optical axis direction, the tapered portions 113 and 124 of the first lens and the second lens functioned as insertion leaders, and those lenses were inserted into the holding member 14. After insertion of the first lens 11, when the first lens planar portion 111 and the second lens planar portion 122 were observed from above the first lens 11, it was confirmed that interference fringes appeared.

Finally, the first lens 11 was retained using a caulking ring (retaining member 13) from above the first lens 11, and the lens unit 1 was assembled. Then, CL-P015 of the CL-3000 series multicolor laser coaxial displacement meter manufactured by KEYENCE was arranged above and below the lens unit to measure the positional relationship between the lenses. At this time, the horizontal positions were aligned with the apex of the first lens 11 and the bottom of the second lens 12 to bring the horizontal positions closer to the lens center, and measurement was performed. The measurement result showed that the overall height of the center portion of the lens unit 1 was 7.740 mm.

Next, the entire lens unit 1 was heated to a temperature of 100 degrees Celsius using a heater and measured again by the same method. The measurement result showed that the overall height of the center portion of the lens unit 1 was 7.744 mm. The variation value of the overall height of the center portion of the lens unit 1, which is calculated from the form of the lens unit 1 and the linear expansion coefficient, is 3.4 μm, and hence it was confirmed that the distance variation between the first lens 11 and the second lens 12 was equal to or smaller than 1 μm, which is good.

### Comparative Example 1

Next, as a comparative example, the lens unit 1 was produced under the following conditions, and the same measurement as in Example 1 was performed. The details are described below.

In this comparative example, for the first lens 11, a convex meniscus lens of M-TAFD305 (manufactured by HOYA: linear expansion coefficient 60×10⁻⁷/° C.) with an outer diameter of Φ32.4 mm, an overall height of 10.0 mm, a center thickness of 5.0 mm, an edge thickness of 1.7 mm, and a tapered portion outer diameter of Φ28.0 mm was used. Further, for the second lens 12, a concave meniscus lens of M-BACD12 (manufactured by HOYA: linear expansion coefficient 69×10⁻⁷/° C.) with an outer diameter of Φ32.4 mm, an overall height of 7.6 mm, a center thickness of 1.9 mm, an edge thickness of 3.6 mm, and a tapered portion outer diameter of @28.0 mm was used. The highest environmental temperature TH was set to a temperature of 100 degrees Celsius. Further, the angles between the first lens tapered portion and the optical axis and between the second lens tapered portion and the optical axis at this time were set to 30 degrees, and the planar portion was arranged outside the tapered portion.

Next, at a place at an indoor temperature of 25 degrees Celsius, the second lens 12 and the first lens 11 were inserted into the holding member 14 in the stated order. At this time, through application of a force from the optical axis direction, the tapered portions of the first lens and the second lens functioned as insertion leaders, and those lenses were inserted into the holding member 14. After insertion of the first lens 11, when the flat portions and tapered portions of the first lens 11 and the second lens 12 were observed from above the first lens 11, it was confirmed that interference fringes were formed on both the lenses.

Finally, the first lens 11 was retained using a caulking ring from above the first lens 11, and the lens unit 1 was assembled. Then, CL-P015 of the CL-3000 series multicolor laser coaxial displacement meter manufactured by KEYENCE was arranged above and below the lens unit 1 to measure the positional relationship between the lenses. At this time, the horizontal positions were aligned with the apex of the first lens 11 and the bottom of the second lens 12 to bring the horizontal positions closer to the center of the lens, and measurement was performed. The measurement result showed that the overall height of the center portion of the lens unit 1 was 7.740 mm.

Next, the entire lens unit 1 was heated to a temperature of 100 degrees Celsius using a heater and measured again by the same method. The measurement result showed that the overall height of the center portion of the lens unit was 7.747 mm. The variation value of the overall height of the center portion of the lens unit 1, which is calculated from the form of the lens unit and the linear expansion coefficient, is 3.4 μm, and hence the distance variation between the first lens 11 and the second lens 12 was equal to or larger than 3 μm.

### Example 2

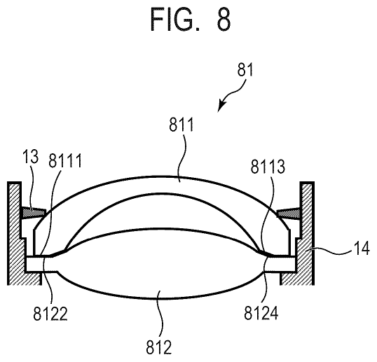

In this example, a lens unit 81 with the structure illustrated in FIG. 8 is used. FIG. 8 shows the lens unit 81 used in this example in the same manner as in FIG. 2 or FIG. 3. The lens unit 81 used in this example differs from the lens unit 1 described with reference to FIG. 2 or FIG. 3 in that a second lens 812 is a double-sided convex lens.

In this example, for a first lens 811, a concave meniscus lens of M-BACD12 (manufactured by HOYA: linear expansion coefficient 69×10⁻⁷/° C.) with an outer diameter of Φ25.5 mm, an overall height of 8.0 mm, a center thickness of 1.8 mm, an edge thickness of 2.7 mm, and a tapered portion outer diameter D1 of @22.5 mm was used. Further, for the second lens 812, a convex lens of M-TAFD305 (manufactured by HOYA: linear expansion coefficient 60×10⁻⁷/° C.) with an outer diameter of @27.0 mm, a center thickness of 7.0 mm, and an edge thickness of 1.5 mm was used. The lowest environmental temperature TL was set to −40 degrees Celsius, and the lens unit 81 was designed.

In this example, the relationship between the linear expansion coefficient α1 of the first lens 811, which has a large tapered portion outer diameter D1, and the linear expansion coefficient α2 of the second lens 812, which has a small tapered portion outer diameter D2, satisfies α1>α2.

Here, assuming that the reference temperature Ts is 25 degrees Celsius, which is the environmental temperature during manufacture, the clearance amount A between an outer peripheral edge of a first lens tapered portion 8113 and an outer peripheral edge of a second lens tapered portion 8124 can be calculated from Formula (2) below.

$$A = ( 25 - TL ) \times ( α 1 - α 2 ) \times D 1 \qquad ( Formula 2 )$$

From A≈0.0015 [mm], the tapered portion outer diameter D1 of the first lens 811 can be obtained by subtracting A from D2, thereby obtaining the outer diameter D1 of Φ22.4985. Further, the angles between the first lens tapered portion 8113 and the optical axis and between the second lens tapered portion 8124 and the optical axis were set to 70 degrees, and a planar portion was arranged outside a tapered surface.

Next, at a place at an indoor temperature of 25 degrees Celsius, the second lens 812 and the first lens 811 were inserted into the holding member 14 in the stated order. At this time, through application of a force from the optical axis direction, the first lens tapered portion 8113 and the second lens tapered portion 8124 functioned as insertion leaders, and those lenses were inserted into the holding member 14. After insertion of the first lens 811, when a first lens planar portion 8111 and a second lens planar portion 8122 were observed from above the first lens 811, it was confirmed that interference fringes were formed on both the lenses.

Finally, the first lens 811 was retained using a caulking ring (retaining member 13) from above the first lens 811, and the lens unit 81 was assembled. Then, CL-P015 of the CL-3000 series multicolor laser coaxial displacement meter manufactured by KEYENCE was arranged above and below the lens unit 1 to measure the positional relationship between the lenses. At this time, the horizontal positions were aligned with the apices of the first lens 811 and the second lens 812 to bring the horizontal positions closer to the center of the lens, and measurement was performed. The measurement result showed that the overall height of the center portion of the lens unit 81 was 12.2 mm.

Next, the entire lens unit 81 was cooled down to a temperature of −40 degrees Celsius and measured again by the same method. The measurement result showed that an overall height of a center portion of the lens unit 81 was 12.195 mm. The variation value of the overall height of the center portion of the lens unit 81, which is calculated from the form of the lens unit 81 and the linear expansion coefficient, is 5.2 μm, and hence it was confirmed that the distance variation between the first lens 811 and the second lens 812 was equal to or smaller than 1 μm, which is good.

As described above, according to the lens unit in this example, highly-accurate positioning of the lenses can be achieved, and high accuracy in an environmental temperature range of from −40 degrees Celsius to 100 degrees Celsius can be maintained.

Next, a lens unit 2001 according to a second embodiment of the present disclosure is described.

The lens unit according to the present disclosure includes a first lens and a second lens, and a tapered abutting portion and a tapered position regulating portion are provided on an outer peripheral portion of each lens. A clearance in the position regulating portion determines positions of the lenses, and a tapered portion to be brought into abutment against another tapered portion reduces a deterioration of positional accuracy due to thermal deformation in the optical axis direction.

### Second Embodiment

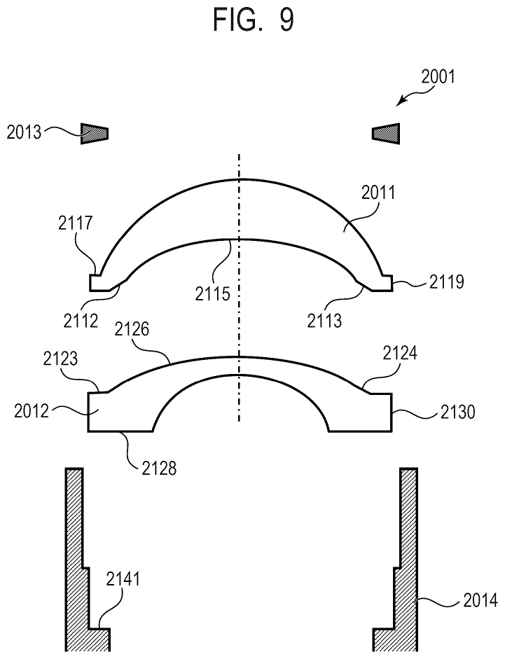

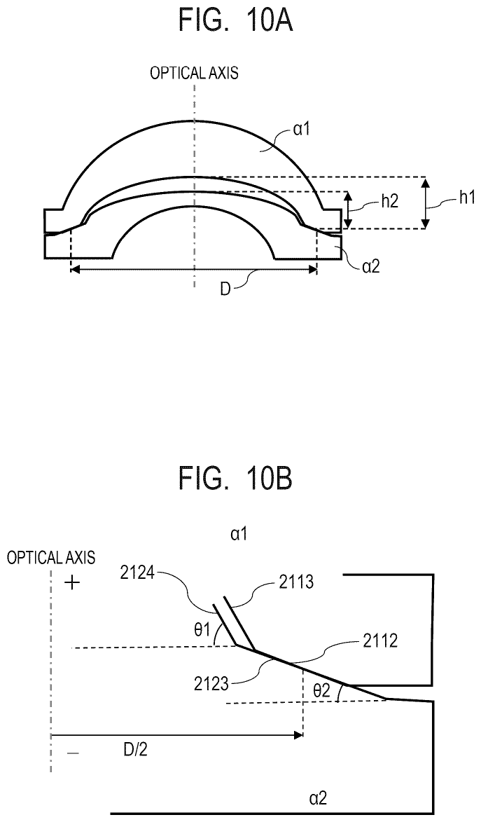

Now, a second embodiment of the present disclosure is described with reference to FIG. 9 to FIG. 11. FIG. 9 is an exploded sectional view of the lens unit 2001 according to the second embodiment, and FIG. 10A and FIG. 10B are sectional views of a first lens 2011 and a second lens 2012, for illustrating a relationship between individual lens tapered portions.

The lens unit 1 is mounted on a surveillance camera or an in-vehicle camera. Thus, the lens unit 2001 is expected to be exposed to, for example, from a low temperature environment of −40 degrees Celsius to a high temperature environment of 100 degrees Celsius. Here, the first lens 2011 and the second lens 2012 are often manufactured as glass lenses made of different materials. In this case, linear expansion coefficients of the lenses are also different. When an environmental temperature changes, for example, in shapes of the first lens and the second lens, which are described later in detail, a positional relationship between lens surfaces in the optical axis direction may change due to, for example, thermal expansion. Such a change in the positional relationship caused by the environmental temperature may cause, for example, a problem in that, even when predetermined optical performance is achieved at the time of lens assembly in a room temperature environment of 25 degrees Celsius, the optical performance cannot be obtained in an environmental temperature of −40 degrees Celsius or 100 degrees Celsius.

The present disclosure is obtained from such a viewpoint. The lens unit 2001 according to this embodiment suppresses changes in lens spacing and reduces deterioration of optical performance even when thermal expansion or thermal contraction occurs in individual lenses due to the environmental temperature of −40 degrees Celsius or 100 degrees Celsius. Next, a specific method of suppressing changes in lens spacing is described.

FIG. 9 is an exploded sectional view of the lens unit 2001 described above. As illustrated in FIG. 9, the first lens 2011 includes a first lens second tapered portion 2112, a first lens first tapered portion 2113, a first lens optical surface 2115, a first lens retaining surface 2117, and a first lens side surface 2119. The first lens optical surface 2115 is a surface that is positioned so as to be opposed to the second lens 2012, and forms an optically effective portion of the first lens 2011. The first lens second tapered portion 2112 has a conical surface shape, and is provided around an outer periphery of the first lens optical surface 2115 being a surface on a side on which the second lens 2012 is located. The first lens first tapered portion 2113 is a surface provided on the outer periphery of the first lens optical surface 2115 and on an inner periphery of the first lens second tapered portion 2112, and is configured to have a conical surface shape. In this embodiment, the first lens first tapered portion 2113 is provided so as to be continuous with the first lens optical surface 2115 at the outer periphery of the first lens optical surface 2115 and continuous with the first lens second tapered portion 2112 at the inner periphery of the first lens second tapered portion 2112.

However, between the outer periphery of the first lens optical surface 2115 and the first lens first tapered portion 2113, a first rounded portion with a curvature different from that of the first lens optical surface 2115 may be provided, and a non-continuous mode can be also employed. Further, between the first lens first tapered portion 2113 and the first lens second tapered portion 2112, a second rounded portion having a curvature may be provided, and a non-continuous mode can be also employed. The first lens retaining surface 2117 is provided around an outer periphery of a surface on a side opposite to the second lens 2012, and is a surface to be brought into abutment against a retaining member 2013. The first lens side surface 2119 is configured as a surface that is parallel to the optical axis and opposed to an inner peripheral surface of a holding member 2014.

The second lens 2012 includes a second lens second tapered portion 2123, a second lens first tapered portion 2124, a second lens optical surface 2126, a holding member contact surface 2128, and a second lens side surface 2130. The second lens optical surface 2126 is a surface that is arranged so as to be opposed to the first lens optical surface 2115, and forms an optically effective portion of the second lens 2012. The second lens second tapered portion 2123 has a conical surface shape, and is provided around an outer periphery of the second lens optical surface 2126 being a surface on a side on which the first lens 2011 is located. The second lens first tapered portion 2124 is a surface provided around the outer periphery of the second lens optical surface 2126 and around an inner periphery of the second lens second tapered portion 2123, and is configured to have a conical surface shape. In this embodiment, the second lens first tapered portion 2124 is provided so as to be continuous with the second lens optical surface 2126 at the outer periphery of the second lens optical surface 2126. However, between the outer periphery of the second lens optical surface 2126 and the second lens first tapered portion 2124, a third rounded portion with a curvature different from that of the second lens optical surface 2126 may be provided, and a non-continuous mode can be also employed. Further, between the second lens first tapered portion 2124 and the second lens second tapered portion 2123, a fourth rounded portion with a curvature may be provided, and a non-continuous mode can be also employed. The holding member contact surface 2128 is a surface to be brought into abutment against a holding member abutment portion 2141. The second lens side surface 2130 is configured as a surface that is parallel to the optical axis and opposed to the inner peripheral surface of the holding member 2014.

In this case, inner diameters and outer diameters of the first lens second tapered portion 2112 and the second lens second tapered portion 2123 are determined so that at least portions of the conical surface shapes of the second tapered portions can be brought into abutment against each other. Further, the outer diameter and inner diameter of the first lens first tapered portion 2113 and the outer diameter and inner diameter of the second lens first tapered portion 2124 are determined so that the first tapered portions are not brought into abutment against each other at a temperature during manufacture. More preferably, the outer diameters and inner diameters of the first lens first tapered portion and the second lens first tapered portion are determined so that the first tapered portions are brought into abutment against each other at the assumed highest or lowest environmental temperature based on a relationship between the linear expansion coefficients of the first lens 2011 and the second lens 2012. Further, in the above description, the second tapered portion to be brought into abutment against another second tapered portion is provided around the outer periphery of the first tapered portion, but the second tapered portion to be brought into abutment against another second tapered portion may be provided around the inner periphery of the first tapered portion.

The first lens first tapered portion 2113 and the second lens first tapered portion 2124, which are not brought into abutment against each other at the temperature during manufacture, can suppress radial positional variations of the first lens 2011 and the second lens 2012 due to thermal deformation caused by changes in environmental temperature. As a result, even when thermal expansion or thermal contraction of each lens occurs, a risk that the desired optical performance cannot be obtained in the lens unit 2001 can be reduced.

Next, abutment positions of the first lens second tapered portion 2112 and the second lens second tapered portion 2123, which are abutting portions of the first lens 2011 and the second lens 2012, and a suitable taper angle θ2 are described with reference to FIG. 10A and FIG. 10B. FIG. 10A is a sectional view for illustrating dimensions and properties related to thermal deformation of the first lens and the second lens, and FIG. 10B is an enlarged sectional view of a contact region between the first lens 2011 and the second lens 2012. In the following description, the taper angles θ1 and θ2 are each an angle between the horizontal direction and a tapered surface in the cross-section taken along the line A-A of FIG. 1.

First, thermal deformation of the lens in the optical axis direction is described. An amount of thermal deformation of the first lens 2011 in the optical axis direction is expressed as ΔH×h1×α1 where ΔH represents an amount of change in environmental temperature, h1 represents a projection distance in the optical axis direction from the abutting portion to the optical surface of the first lens, and α1 represents a linear expansion coefficient. An amount of thermal deformation of the second lens 2012 in the optical axis direction is expressed as ΔH×h2×α2 where h2 represents a projection distance in the optical axis direction from the abutting portion to the optical surface of the second lens 2012, and α2 represents a linear expansion coefficient. At this time, a distance between the lenses changes by an amount of ΔH×(α1×h1−α2×h2), which is a difference between the amount of thermal deformation of the first lens 2011 and the amount of thermal deformation of the second lens 2012.

Here, influences on the thermal deformation of the lens in the radial direction and in the optical axis direction are described. In a case in which the abutting portion is planar, when the distance from the lens optical axis to the abutment position is represented by D/2, an amount of change in lens position in the radial direction is expressed as ΔH×(α2−α1)×D/2. In this case, as illustrated in FIG. 10A, D represents a diameter of the abutting portion between the first lens second tapered portion 2112 of the first lens 2011 and the second lens second tapered portion 2123 of the second lens 2012. The first lens second tapered portion 2112 and the second lens second tapered portion 2123 have the conical surface shapes, and hence, ideally, the first lens second tapered portion 2112 and the second lens second tapered portion 2123 are brought into surface contact with each other, but in reality, point contact or partial surface contact with each other due to, for example, surface accuracy. In this embodiment, for the sake of convenience, the tapered portions are assumed to be held in surface contact with each other, and a center of the contact surface is defined as the abutting portion. Further, the diameter related to the abutting portion is represented by D, but the abutting portion is not limited to this and can be a portion in which the first lens second tapered portion 2112 and the second lens second tapered portion 2123 are actually brought into abutment against each other. When the portion in which the lenses are brought into abutment against each other in the present disclosure is tapered, the thermal deformation in the radial direction causes slippage between the first lens second tapered portion 2112 and the second lens second tapered portion 2123. This can change the positional relationship between the first lens 2011 and the second lens 2012 in the optical axis direction. When the angle between the first lens second tapered portion 2112 and the horizontal direction or between the second lens second tapered portion 2123 and the horizontal direction is set to θ2, the amount of change in the positional relationship of the optical axis is expressed as ΔH×(α2−α1)×tan θ2×D/2. Accordingly, the angle of the tapered surface and the abutment position are determined from the linear expansion coefficient of each of the first lens 2011 and the second lens 2012 so that ΔH×(α1×h1−α2×h2), which is the difference between the amount of thermal deformation of the first lens 2011 and the amount of thermal deformation of the second lens 2012, is small.

Specifically, the angle of the tapered surface and the abutment position are determined by Formula (3) below. The best mode is to equalize the amount of change obtained from the differences in thermal deformation in the optical axis direction between the first lens and the second lens, ΔH×(h2×α2−h1×α1) and ΔH×(α2−α1)×tan θ2×D/2, and the angle of the tapered surface and the abutment position may be set to offset those differences.

$$\vert ( h 2 \times α 2 - h 1 \times α 1 ) \vert \geq \vert ( h 2 \times α 2 - h 1 \times α 1 ) - ( α 2 - α 1 ) \times tan θ 2 \times D / 2 \vert \qquad Formula ( 3 )$$

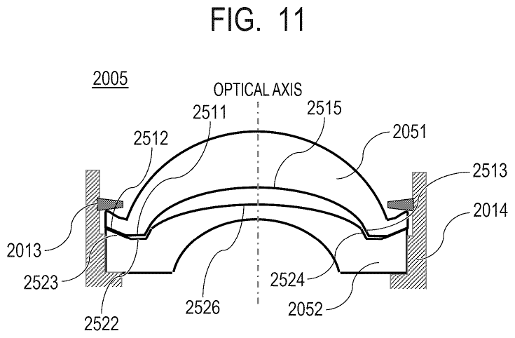

In this case, when α1>α2 and α1×h1>α2×h2 are satisfied, or when α1<α2 and α1×h1<α2×h2 are satisfied, it is preferred that the outer periphery be tapered toward the second lens as illustrated in FIG. 10A. Further, when α1>α2 and α1×h1<α2×h2 are satisfied, or when α1<α2 and α1×h1>α2×h2 are satisfied, owing to the outer periphery that is tapered toward the first lens as illustrated in FIG. 11, directions of thermal deformation in the optical axis direction match each other, thereby reducing positional deterioration between the lenses.

FIG. 11 shows a modification example of the lens unit according to this embodiment, which is configured so as to correspond to the condition of α1>α2 and α1×h1<α2×h2 and the condition of α1<α2 and α1×h1>α2×h2. The same reference symbols are used for the same configuration as that of the lens unit 1 described with reference to FIG. 9, for example, and the description is omitted here. A lens unit 2005 illustrated as a modification example includes a first lens 2051 and a second lens 2052. On one surface of the first lens 2051, there are provided a first lens optical surface 2515, a first lens first tapered portion 2513, a first lens planar portion 2511, and a first lens second tapered portion 2512 in the stated order from the first lens optical surface 2515 provided at a substantially center. Further, on one surface of the second lens 2052, there are provided a second lens optical surface 2526, a second lens first tapered portion 2524, a first lens planar portion 2522, and a first lens second tapered portion 2523 in the stated order from the second lens optical surface 2526 provided at a substantially center. The first lens 2051 and the second lens 2052 are arranged so that the first lens optical surface 2515 and the second lens optical surface 2526 are opposed to each other. In this modification example, the arrangement of the first tapered portion and the second tapered portion with respect to the optical surface in each lens is different from the above-mentioned embodiment. However, the same effect can be obtained in the arrangement when the above-mentioned conditions are satisfied.

Next, suitable taper angles of the first lens second tapered portion 2112, the first lens first tapered portion 2113, the second lens second tapered portion 2123, and the second lens first tapered portion 2124 are described with reference to FIG. 10B. The taper angles (01, 02) described later are each the angle between each tapered portion and the horizontal direction.

The first lens first tapered portion 2113 and the second lens first tapered portion 2124 are required to function to prevent the radial positional relationship between the lenses from being changed by a gap amount or more at a temperature during manufacture when thermal deformation of the first lens 2011 and the second lens 2012 in the radial direction occurs due to changes in environmental temperature. That is, a shape that bears load in the radial direction more is preferred. Accordingly, it is preferred that the taper angles θ1, which are the angles between the first lens first tapered portion 2113 and the horizontal direction and between the second lens first tapered portion 2124 and the horizontal direction be equal to or larger than 45 degrees and equal to or smaller than 90 degrees. Further, it is preferred that the taper angles be equal to each other in order to maintain the spacing between the tapered portions until just before the tapered portions are brought into contact with each other.

As described above, it is preferred that the angle θ1 of the first lens first tapered portion 2113 and the angle θ1 of the second lens first tapered portion 2124 be equal to each other, and that the angles with respect to the horizontal direction be equal to or larger than 45 degrees and equal to or smaller than 90 degrees from the viewpoint of regulating the positions of the lenses. It is preferred that the angle θ2 of the first lens second tapered portion 2112 and the angle θ2 of the second lens second tapered portion 2123 be equal to each other so that those tapered portions can be brought into surface contact with each other. Further, regarding the angle of the first tapered portion and the angle of the second tapered portion, it is preferred that the angle θ1 be larger than the angle θ2 due to the difference in viewpoint described above. When the respective taper angles meet those conditions, even when thermal expansion or thermal contraction of each lens occurs, the lens unit 2001 can be easily manufactured with reduced risk that the desired optical performance cannot be obtained.

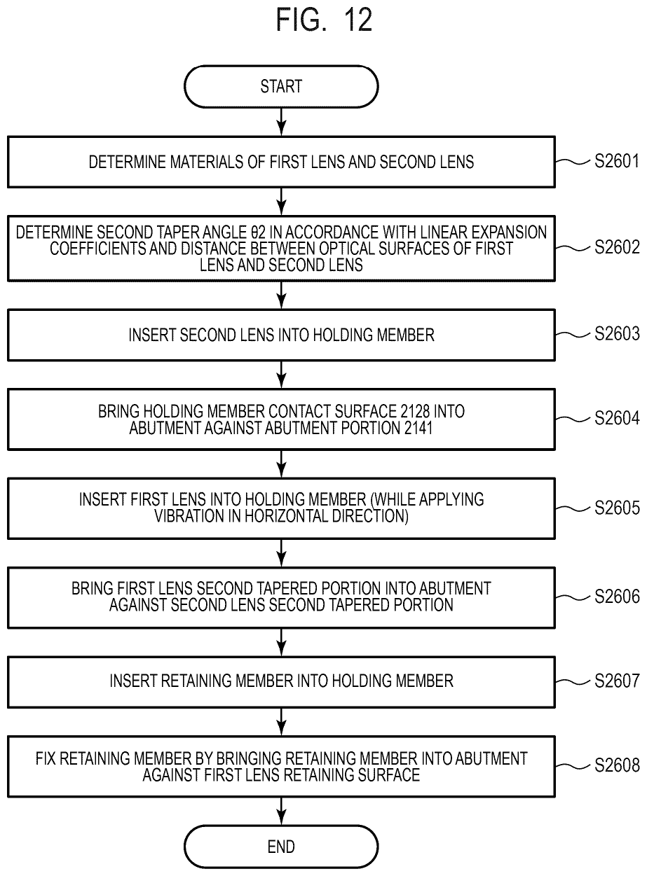

Next, assembly of the lens unit 1 according to an aspect of the present disclosure is described with reference to a flowchart in FIG. 12.

First, in Step S2601, based on optical conditions required for the lens unit 1, a material of the first lens 2011, a material of the second lens 2012, and a shape of each optical surface are determined. Next, in Step S2602, based on the linear expansion coefficient α1 of the first lens 2011, the linear expansion coefficient α2 of the second lens 2012, and a distance between the optical surfaces of the first lens 2011 and the second lens 2012, the angle θ2 of each of the second tapered portions and the abutment position are determined. Further, the angle θ1 of each of the first tapered portions is also determined. As a result, dimensions of the first lens 2011 and dimensions of the second lens 2012 are determined, and those lenses are manufactured.

Next, in Step S2603, the second lens 2012 is inserted into the holding member 2014.

This operation is completed by bringing the holding member contact surface 2128 of the second lens and the holding member abutment portion 2141 into abutment against each other in Step S2604. The holding member contact surface 2128 of the second lens is provided around an outer peripheral portion of a surface of the second lens 2012 opposite to the surface provided with the second lens optical surface 2126, and forms a planar portion. At this time, the second lens side surface 2130 of the second lens may or may not be held in contact with the holding member 2014.

Next, in Step S2605, the first lens 2011 is inserted into the holding member 2014.

At this time, insertion is performed while applying vibration to the holding member 2014 and the first lens 2011 in a direction (horizontal direction) in a plane perpendicular to the inserting direction. This operation is completed by bringing the first lens second tapered portion 2112 into abutment against the second lens second tapered portion 2123 in Step S2606.

Through application of vibration in the horizontal plane during insertion of the first lens 2011 as described above, the optical axes of those lenses are aligned. Accordingly, when any one of the first lens side surface 2119 of the first lens 2011 and the second lens side surface 2130 of the second lens 2012 is fixed to the inner periphery of the holding member 2014, the other lens is also arranged at a desired position with respect to the holding member 2014. Further, by determining which of the first lens side surface 2119 and the second lens side surface 2130 is brought into abutment against the holding member 2014 according to the relationship in difference between the assumed temperature during use and the reference temperature during manufacture, it is possible to eliminate constraint from the abutment surface on thermal deformation of the lens that is free from abutment. As described above, only one of those lenses is brought into abutment against the inside of the holding member 2014, which facilitates alignment of each lens in the optical axis direction. However, in cases in which constraint on the lens outer diameter by the holding member 2014 is not so problematic, for example, when the assumed temperature is not so different from the reference temperature during manufacture, or when the holding member 2014 is relatively easily deformable, both the lenses may be brought into abutment against the inside of the holding member 2014.

Finally, in Step S2607, the retaining member 2013 is inserted into the holding member 2014. Then, in Step S2608, the retaining member 2013 is fixed to the holding member 2014 by bringing the retaining member 2013 into abutment against the first lens retaining surface 2117. The lens unit according to the present disclosure can be manufactured, for example, through the above-mentioned process.

In the embodiment described above, the retaining member 2013 is illustrated as, for example, a cylindrical part such as a caulking ring, but its mode is not limited to the shape of the embodiment. For example, parts such as a plurality of claws or screws can be used as the retaining member 2013. Further, the manufacturing method described above is an example, and the process other than the method of determining the angle of the second tapered portion and the abutment position in Step S2602 can be substituted by various known and available methods.

Further, in order to obtain the effect of the present disclosure, it is preferred that both the lenses thermally expand or contract individually according to the environmental temperature, and thus it is preferred that the first lens optical surface 2115 of the first lens 2011 and the second lens optical surface 2126 of the second lens 2012 be spaced apart from each other.

### Application Example of Second Embodiment

The image pickup apparatus on which the lens unit 2001 according to the second embodiment described above is mounted is also applicable to the in-vehicle camera exemplified in the first embodiment.

As described above, the lens unit 2001 according to the present disclosure includes at least the first lens 2011 and the second lens 2012. The first lens 2011 includes, for example, the first lens optical surface 2115, the first lens first tapered portion 2113 provided around the outer periphery of the first lens optical surface 2115, and the first lens second tapered portion 2112 provided around the outer periphery of the first lens optical surface 2115. The second lens 2012 includes, for example, the second lens optical surface 2126 opposed to the first lens optical surface 2115, and the second lens first tapered portion 2124 provided around the outer periphery of the second lens optical surface 2126 so as to be opposed to the first lens first tapered portion 2113. The second lens 2012 further includes the second lens second tapered portion 2123 that is provided around the outer periphery of the second lens optical surface 2126 and arranged so as to be brought into abutment against the first lens second tapered portion 2112 at the abutting portion. The first lens second tapered portion 2112 and the second lens second tapered portion 2123 have the same taper angle (02, angle between the tapered surface and the direction perpendicular to the optical axis), and are arranged so as to be brought into abutment against each other on the conical surfaces of the second tapered portions. The abutting portion, which is ideally the abutment surface, can be, for example, a center portion of the abutment surface (contact region between the tapered portions 2112 and 2123 in FIG. 10B) in order to define a reference portion for deformation in view of, for example, thermal deformation. Based on the optical conditions required for the lens unit 2001, the material of the first lens 2011, the material of the second lens 2012, and the shape of each optical surface are selected. This selection is made so that the change in the distance between the surfaces of the first lens 2011 and the second lens 2012 in the optical axis direction during thermal deformation is small.

Further, in this case, in an environment at a temperature of 25° C., the distance between the outer peripheral edge of the first lens first tapered portion 2113 and the outer peripheral edge of the second lens first tapered portion 2124 is set apart by a predetermined distance. More specifically, the angle θ2 of the second tapered portion and the abutment position are determined by α1, α2 and D as shown in Formula (3). In the embodiment described above, the reference temperature during manufacture, 25 degrees Celsius, is described as the reference temperature, but the reference temperature is not limited to this. For example, in consideration of mounting the lens unit on an in-vehicle camera, the average temperature in the use environment of the in-vehicle camera may be used as the reference temperature. Further, a temperature of 100 degrees Celsius is adopted as the assumed temperature in the embodiment, but the upper limit of the assumed temperature is not limited to 100 degrees Celsius. For example, the upper limit of the assumed temperature may be set by multiplying a safety factor to the highest value of the temperature of the in-vehicle camera actually measured outdoors.

Further, in the embodiment described above, the case in which the temperature of −40 degrees Celsius is the lower limit of the assumed temperature is adopted. However, for example, the lower limit of the assumed temperature may be set by multiplying a safety factor to the lowest value of the temperature of the in-vehicle camera actually measured outdoors.

Here, it is preferred that the angles between the first lens first tapered portion 2113 and the direction perpendicular to the optical axis and between the second lens first tapered portion 2124 and the direction perpendicular to the optical axis be larger than the angles between the first lens second tapered portion 2112 and the direction perpendicular to the optical axis and between the second lens second tapered portion 2123 and the direction perpendicular to the optical axis. Further, it is preferred that the angles between the first lens first tapered portion 2113 of the first lens 2011 and the direction perpendicular to the optical axis and between the second lens first tapered portion 2124 of the second lens 2012 and the direction perpendicular to the optical axis be equal to or larger than 45 degrees and equal to or smaller than 90 degrees in terms of lens position regulation of the lens unit 2001.

As described above, the lens unit 2001 according to the present disclosure also includes the holding member 2014 that accommodates the first lens 2011 and the second lens 2012. The holding member 2014 can include the holding member abutment portion 2141 that is brought into abutment against the holding member contact surface 2128 provided on a surface opposite to the surface on which the second lens second tapered portion 2123 is formed. The holding member abutment portion 2141 can be provided to protrude inwardly from the inner peripheral surface of the holding member 2014 having a cylindrical shape. The lens unit 2001 further includes the retaining member 2013 that is brought into abutment against the surface (2117) provided on a side opposite to the surface provided with the first lens second tapered portion 2112 and sandwiches the first lens 2011 and the second lens 2012 together with the holding member abutment portion 2141. At least one or both of the outer peripheral surface (side surface 2119) of the first lens 2011 and the outer peripheral surface (side surface 2130) of the second lens 2012 can be brought into abutment against the inner peripheral surface of the holding member 2014. Further, in the illustrated embodiment, the first lens optical surface 2115 and the second lens optical surface 2126 are spaced apart from each other.

Further, the present disclosure may also be constructed as a method of manufacturing the lens unit described above. The method includes inserting the second lens 2012 into the holding member 2014, and inserting the first lens 2011 into the holding member 2014 and continuing the insertion until the first lens second tapered portion 2112 is brought into abutment against the second lens second tapered portion 2123 at the abutting portion. The method further includes inserting the retaining member 2013 into the holding member 2014 to fix those lenses to the holding member 2014. Further, when fixing the lenses, the retaining member 2013 presses and fixes the first lens 2011 in the inserting direction of the first lens 2011 from the first lens retaining surface 2117, which is the surface opposite to the surface of the first lens 2011 provided with the first lens second tapered portion 2112. Here, the first lens first tapered portion 2113 and the second lens first tapered portion 2124 are spaced apart from each other. The angle θ2 of each second tapered portion and the abutment position are determined based on Formula (3).

Through use of the lens unit 2001 described above or the lens unit 2001 obtained by the manufacturing method, in the lens unit 2001, even under, for example, the use environment of the in-vehicle camera, it is possible to reduce the risk that the desired optical performance cannot be obtained. The present disclosure describes the example of applying the lens unit 2001 to an in-vehicle camera. However, the lens unit 2001 according to the present disclosure is also applicable to image pickup apparatus other than in-vehicle cameras, such as compact digital cameras, single-lens reflex digital cameras, mirror-less digital cameras, and mobile devices such as smartphones and tablets. Further, the lens unit 2001 is also applicable to optical devices such as binoculars, microscopes, and telescopes. Those optical devices include an optical system including the lens unit 2001 described above, and a housing that houses the optical system.

### EXAMPLES

The effects of the present disclosure are described later with reference to examples embodying the second embodiment of the present disclosure and comparative examples with respect to the examples. The following examples are examples of the present disclosure, and the present disclosure is not limited to the following examples.

Further, a positional variation of each lens in the optical axis direction was measured under a state in which CL-P015 and CL-P070 of the CL-3000 series multicolor laser coaxial displacement meter manufactured by KEYENCE were arranged above and below the lens unit 1.

### Example 3

In this example, M-TAFD305 (manufactured by HOYA: linear expansion coefficient α1-60×10⁻⁷/° C.) was used for the first lens 2011. Further, the lens shape was a convex meniscus lens with an outer diameter of @36.6 mm, a center thickness of 6.8 mm, and an edge thickness of 1.7 mm. M-PCD55AR (manufactured by HOYA: linear expansion coefficient α2=92×10⁻⁷/° C.) was used for the second lens 2012. The lens shape was a concave meniscus lens with an outer diameter of @36.6 mm, an overall height of 8.0 mm, a center thickness of 1.8 mm, and an edge thickness of 2.8 mm.

In this case, dimensions of each lens were determined using Formula (3) so that the amount of deformation due to thermal deformation was small. Specifically, the outer diameter D of the abutting portion was set to φ30 mm, a projection distance h1 in the optical axis direction from the abutting portion to the first lens optical surface was set to 12 mm, a projection distance h2 in the optical axis direction from the abutting portion to the second lens optical surface was set to 11 mm, and the angle θ2 of the second tapered portion was set to 31 degrees. Further, the outer diameter of the first lens first tapered portion was set to φ27.005 mm, the outer diameter of the second lens first tapered portion was set to φ27.000 mm, and the taper angle θ1 was set to 60 degrees.

Next, at a place at an indoor temperature of 25 degrees Celsius, the second lens and the first lens were inserted into the holding member in the stated order. At this time, through application of a force from the optical axis direction, the tapered portions of the first lens and the second lens functioned as insertion leaders, and those lenses were inserted into the holding member. After insertion of the first lens, when the first lens second tapered portion and the second lens second tapered portion were observed from above the first lens, it was confirmed that interference fringes appeared. The formation of those interference fringes confirms that the first lens second tapered portion and the second lens second tapered portion are held in abutment against each other on the surfaces of the second tapered portions.

Finally, the first lens 2011 was retained using a caulking ring (retaining member 13) from above the first lens 2011, and the lens unit 2001 was assembled. Then, CL-P015 of the CL-3000 series multicolor laser coaxial displacement meter manufactured by KEYENCE was arranged above and below the lens unit to measure the positional relationship between the lenses. At this time, the horizontal positions were aligned with the apex of the first lens 2011 and the bottom of the second lens 2012 to bring the horizontal positions closer to the lens center, and measurement was performed. The measurement result showed that the overall height of the center portion of the lens unit 2001 was 10.360 mm.

Next, the entire lens unit 2001 was heated to a temperature of 100 degrees Celsius using a heater and measured again by the same method. The measurement result showed that the overall height of the center portion of the lens unit 1 was 10.368 mm. The variation value of the overall height of the center portion of the lens unit 2001, which is calculated from the form of the lens unit 2001 and the linear expansion coefficient, is 8.5 μm, and hence it was confirmed that the distance variation between the first lens 2011 and the second lens 2012 was equal to or smaller than 1 μm, which is good.

### Comparative Example 2

Next, as a comparative example, the lens unit was produced under the following conditions, and the same measurement as in Example 3 was performed. The details are described later.

In this comparative example, similarly to Example 3, for the first lens, M-TAFD305 (manufactured by HOYA: linear expansion coefficient 60×10⁻⁷/° C.) was used. Further, the lens shape was a convex meniscus lens with an outer diameter of @36.6 mm, a center thickness of 6.8 mm, and an edge thickness of 1.7 mm. For the second lens, M-PCD55AR (manufactured by HOYA: linear expansion coefficient α2=92×10⁻⁷/° C.) was used. The lens shape was a concave meniscus lens with an outer diameter of 36.6 mm, an overall height of 8.0 mm, a center thickness of 1.8 mm, and an edge thickness of 2.8 mm.

In this case, in Example 3, the abutting portion, which corresponds to the second tapered portion, is not tapered but formed into a flat surface. As for the first tapered portion, similarly to Example 3, the outer diameter of the first tapered portion of the first lens was set to φ27.005 mm, the outer diameter of the first tapered portion of the second lens was set to φ27.000 mm, and the taper angle θ1 was set to 60 degrees.

Next, at a place at an indoor temperature of 25 degrees Celsius, the second lens and the first lens were inserted into the holding member in the stated order. At this time, through application of a force from the optical axis direction, the first tapered portions of the first lens and the second lens functioned as insertion leaders, and those lenses were inserted into the holding member. After insertion of the first lens, when the flat surfaces of the first lens and the second lens, which are abutting portions, were observed from above the first lens, it was confirmed that interference fringes were formed.

Finally, the first lens was retained using a caulking ring (retaining member 13) from above the first lens, and the lens unit was assembled. Then, CL-P015 of the CL-3000 series multicolor laser coaxial displacement meter manufactured by KEYENCE was arranged above and below the lens unit to measure the positional relationship between the lenses. At this time, the horizontal positions were aligned with the apex of the first lens and the bottom of the second lens to bring the horizontal positions closer to the center of the lens, and measurement was performed. The measurement result showed that the overall height of the center portion of the lens unit was 10.453 mm.

Next, the entire lens unit was heated to a temperature of 100 degrees Celsius using a heater and measured again by the same method. The measurement result showed that the overall height of the center portion of the lens unit 1 was 10.464 mm. The variation value of the overall height of the center portion of the lens unit 1, which is calculated from the form of the lens unit and the linear expansion coefficient, is 8.5 μm, and hence the distance variation between the first lens and the second lens was equal to or larger than 2 μm.

The present disclosure has been described above referring to the embodiments, the modification examples, and examples. However, the present disclosure is not limited to the above-mentioned embodiments. The present disclosure also encompasses the invention modified within a scope not deviated from the present invention, and the invention equivalent to the present disclosure. Further, the above-mentioned embodiments, the modification examples, and examples may be combined with each other as appropriate within the scope not deviated from the present disclosure.

According to one aspect of the present disclosure, it is possible to provide a lens unit capable of maintaining desired optical performance even when a temperature range in a use environment is wide.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-171416, filed Oct. 2, 2023 and No. 2023-216630, filed Dec. 22, 2023, which are hereby incorporated by reference herein in their entirety.

What is claimed is:

1. A lens unit comprising:
a first lens including:
a first lens tapered portion; and
a first lens planar portion provided so as to be continuous with an outer periphery of the first lens tapered portion and perpendicular to an optical axis; and
a second lens, which is opposed to the first lens, and includes:
a second lens tapered portion provided so as to be apart from and opposed to the first lens tapered portion; and
a second lens planar portion that is provided so as to be continuous with an outer periphery of the second lens tapered portion and perpendicular to the optical axis, and is brought into abutment against the first lens planar portion,
wherein a diameter D1 of an outer peripheral edge of the first lens tapered portion is larger than a diameter D2 of an outer peripheral edge of the second lens tapered portion,
wherein the outer peripheral edge of the first lens tapered portion and the outer peripheral edge of the second lens tapered portion are spaced apart by a predetermined distance at a predetermined temperature, and
wherein in an environment at a temperature higher or lower than the predetermined temperature, a distance between the outer peripheral edge of the first lens tapered portion and the outer peripheral edge of the second lens tapered portion is smaller than the predetermined distance.

2. The lens unit according to claim 1, wherein each of the first lens tapered portion and the second lens tapered portion forms an angle equal to or smaller than 90 degrees with respect to a direction perpendicular to the optical axis.

3. The lens unit according to claim 1, wherein the predetermined temperature is room temperature.

4. The lens unit according to claim 1,
wherein the first lens includes a first lens optical surface inside the first lens tapered portion, and
wherein the second lens includes a second lens optical surface inside the second lens tapered portion.

5. The lens unit according to claim 1,
wherein in an environment at a temperature higher than the predetermined temperature, the distance between the outer peripheral edge of the first lens tapered portion and the outer peripheral edge of the second lens tapered portion is smaller than the predetermined distance, and
wherein the predetermined distance is equal to or larger than a distance determined by 75×(α2−α1)×D2,
where α1 represents a linear expansion coefficient of the first lens, and α2, which is larger than α1, represents a linear expansion coefficient of the second lens.

6. The lens unit according to claim 1,
wherein in an environment at a temperature lower than the predetermined temperature, the distance between the outer peripheral edge of the first lens tapered portion and the outer peripheral edge of the second lens tapered portion is smaller than the predetermined distance, and
wherein the predetermined distance is equal to or larger than a distance determined by 65×(α1−α2)×D1,
where α1 represents a linear expansion coefficient of the first lens, and α2, which is larger than α1, represents a linear expansion coefficient of the second lens.

7. The lens unit according to claim 1, wherein angles between the first lens tapered portion and the optical axis and between the second lens tapered portion and the optical axis are equal to or larger than 45 degrees and smaller than 90 degrees.

8. The lens unit according to claim 1, wherein angles between the first lens tapered portion and the optical axis and between the second lens tapered portion and the optical axis are equal to or larger than 45 degrees and smaller than 67 degrees.

9. The lens unit according to claim 1, wherein a static friction coefficient between the first lens planar portion and the second lens planar portion is equal to or smaller than 0.5.

10. The lens unit according to claim 1,
wherein the first lens planar portion is provided around the outer periphery of the first lens tapered portion, and
wherein the second lens planar portion is provided around the outer periphery of the second lens tapered portion.

11. The lens unit according to claim 1,
wherein the first lens planar portion and the first lens tapered portion are provided continuously, and
wherein the second lens planar portion and the second lens tapered portion are provided continuously.

12. The lens unit according to claim 1, wherein the first lens and the second lens are glass lenses.

13. The lens unit according to claim 1, further comprising:
a holding member that accommodates the first lens and the second lens, and includes an abutment portion that is brought into abutment against a planar portion provided on a surface opposite to the second lens planar portion; and
a retaining member that is brought into abutment against a surface opposite to the first lens planar portion, and sandwiches the first lens and the second lens together with the abutment portion.

14. A lens unit comprising:
a first lens including:
a first lens first tapered portion; and
a first lens second tapered portion provided continuously on an outer side of the first lens first tapered portion; and
a second lens, which is opposed to the first lens, and includes:
a second lens first tapered portion provided so as to be apart from and opposed to the first lens first tapered portion; and
a second lens second tapered portion that is brought into abutment against the first lens second tapered portion at an abutting portion and provided continuously on an outer side of the second lens first tapered portion.

15. The lens unit according to claim 14, wherein each of the first lens first tapered portion, the first lens second tapered portion, the second lens first tapered portion, and the second lens second tapered portion forms an angle equal to or smaller than 90 degrees with respect to a direction perpendicular to an optical axis.

16. The lens unit according to claim 14, wherein an angle between the first lens first tapered portion and an optical axis is larger than an angle between the first lens second tapered portion and the optical axis.

17. The lens unit according to claim 14,
wherein a diameter of the first lens first tapered portion is larger than a diameter of the second lens second tapered portion, and
wherein a formula |(h2×α2−h1×α1)|≥|(h2×α2−h1×α1)−(α2−α1)×tan θ×D/2| is satisfied,
where α1 represents a linear expansion coefficient of the first lens, h1 represents a distance in an optical axis direction between an apex of a surface of the first lens on the second lens side and the abutting portion, α2 represents a linear expansion coefficient of the second lens, h2 represents a distance in the optical axis direction between an apex of a surface of the second lens on the first lens side and the abutting portion, D represents an outer diameter of the abutting portion, and θ represents an angle between a tapered surface forming the abutting portion and a direction perpendicular to the optical axis.

18. The lens unit according to claim 14, wherein angles between the first lens first tapered portion and a direction perpendicular to an optical axis and between the second lens first tapered portion and the direction perpendicular to the optical axis are larger than angles between the first lens second tapered portion and the direction perpendicular to the optical axis and between the second lens second tapered portion and the direction perpendicular to an optical axis.

19. The lens unit according to claim 14, wherein angles between the first lens first tapered portion and a direction perpendicular to an optical axis and between the second lens first tapered portion and the direction perpendicular to the optical axis are equal to or larger than 45 degrees and equal to or smaller than 90 degrees.

20. The lens unit according to claim 14, further comprising:
a cylindrical holding member that accommodates the first lens and the second lens,
wherein at least one of an outer peripheral surface of the first lens or an outer peripheral surface of the second lens is brought into abutment against an inner peripheral surface of the holding member.

21. An optical device comprising:
an optical system including the lens unit of claim 1; and
a housing that houses the optical system.

22. An image pickup apparatus comprising:
an optical system including the lens unit of claim 1;
an image pickup element configured to receive light having passed through the optical system; and
a housing that houses the optical system and the image pickup element.
